(19) United States
(12) Patent Application Publication
(10) Pub. No.: US 2014/0326908 A1
(43) Pub. Date: Nov. 6, 2014

(54) VALVE CONTROL DEVICE FOR A VEHICLE

(71) Applicants: Markus Schober, Homburg (DE); Andreas Wehle, Nussloch (DE)

(72) Inventors: Markus Schober, Homburg (DE); Andreas Wehle, Nussloch (DE)

(21) Appl. No.: 14/001,592

(22) PCT Filed: Mar. 13, 2012
(86) PCT No.: PCT/EP12/54324

§ 371 Date: Nov. 21, 2013

(30) Foreign Application Priority Data
Mar. 21, 2011 (DE) 10-2011-005-868.0

(51) Int. Cl. F15B 19/00

(52) U.S. Cl. CPC F15B 19/00
USPC 251/129.04

(57) ABSTRACT

A valve control device for a vehicle, in particular, an agricultural, commercial vehicle, comprises a control unit for the control of an electromagnetically actuatable valve, wherein the control unit, upon activation of a self-calibration mode, requests an identification feature correlated with the electromagnetically valve, determines a valve type corresponding to the requested identification feature, and selects a control algorithm correlated with the determined valve type to control the electromagnetically actuatable valve. In accordance with the invention, the identification feature is a characteristic actuating distance of an actuating unit provided for the electromagnetic actuation of the valve.

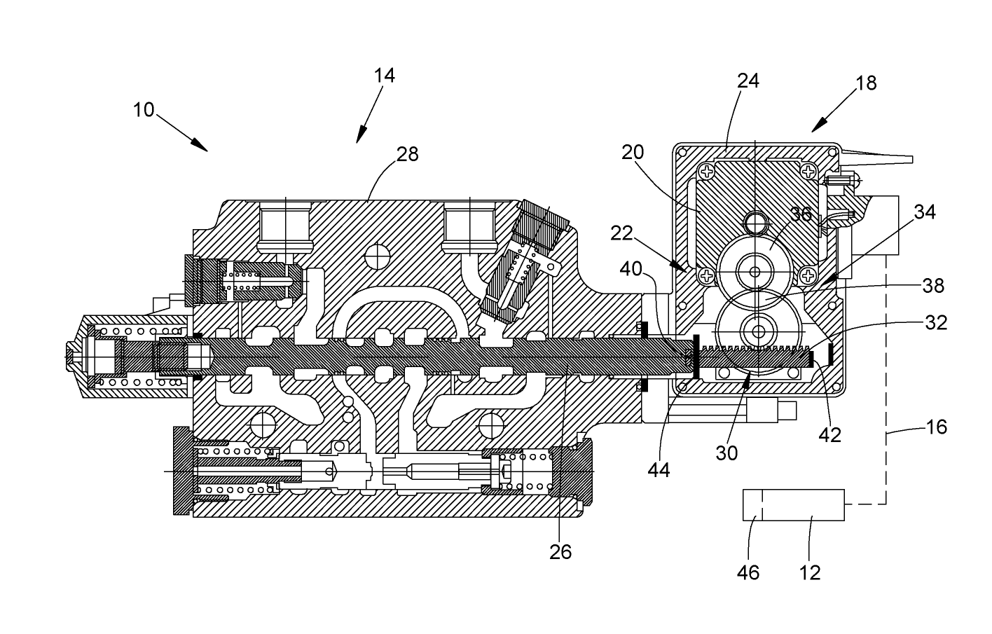

The invention concerns a valve control device for a vehicle, in particular, an agricultural, commercial vehicle, with a control unit to control an electromagnetically actuatable valve, wherein the control unit requests an identification feature correlated with the electromagnetically actuatable valve when a self-calibration mode is activated, determines a valve type, corresponding to the requested identification feature, and selects a control algorithm correlated with the determined valve type to control the electromagnetically actuatable valve.

Such a valve control device, in the form of a system for the identification of the configuration of a valve carrier system that can be equipped with various valves, was presented, for example, by the Bosch Rexroth Company, at the Hannover Fair in 2009. The valve carrier system has a plurality of base plates to hold the valves, wherein each of the base plates carries an antenna, by means of which it is possible to read an RFID transponder correlated with the individual valve. Each of the RFID transponders hereby transfers a data set characteristic for the individual valve type, so that a direct conclusion as to the current equipping of the valve carrier system is possible. As a result of the use of the RFID-based data request, the known valve control device is relatively expensive in its structure.

Therefore, it is the goal of the invention under consideration to develop a valve control device of the type mentioned in the beginning, in the sense of a reduction in the construction expense.

This goal is attained by a valve control device with the features of Patent Claim 1.

The valve control device for a vehicle, in particular, an agricultural, commercial vehicle, comprises a control unit for the control of an electromagnetically actuatable valve, wherein the control unit requests an identification feature correlated with the electromagnetically actuatable valve when a self-calibration mode is activated, determines a valve type corresponding to the requested identification feature, and selects a control algorithm correlated with the determined valve type to control the electromagnetically actuatable valve. In accordance with the invention, the identification feature is a characteristic actuating distance of an actuating unit provided for the electromagnetic actuation of the valve.

The actuating unit can, for example, be designed as an electrically controllable actuator in the form of a stepping motor, which is connected with a valve slide correlated with the valve via a corresponding driving mechanism. The valve slide conducted in a valve block allows placement in various positions by means of the actuator, wherein each of the positions corresponds to a specific valve position. The actuating distance traversed by the valve slide between the various positions is hereby characteristic for the individual valve type—that is, permits its clear identification.

No special demands are made in the determination of the characteristic actuation position itself. If the actuator is a stepping motor, then the characteristic actuating distance can be derived directly from the number of the steps needed by the stepping motor to traverse the actuating distance completely. Additionally or alternatively, however, the use of a position sensor to detect the actuating distance is also conceivable.

The valve control device in accordance with the invention does not just simplify a first configuration of a hydraulic system provided in a vehicle for the case of a plurality of available valve options, but rather also a late replacement of the valve type within the scope of maintenance or revision operations. The various valve types and their corresponding identification features or control algorithms are hereby deposited in tables in a storage device correlated with the control unit. After the configuration of the hydraulic system has been concluded, the self-calibration mode is abandoned and the valve control device is placed in a normal operation mode provided for the normal operation of the hydraulic system.

Advantageous refinements of the valve control device in accordance with the invention can be deduced from the dependent claims.

Preferably, the control unit determines the characteristic actuating distance with the aid of specified reference positions of the actuator comprised by the actuating unit. The actuator can, for example, be a rack connected with the valve slide, which rack engages with a gear drive of the stepping motor. The rack and the gear drive consisting of one or more gear wheels are a component of the driving mechanism comprised by the actuating unit.

Each of the reference positions of the actuator corresponds hereby to a specific valve position. The actuator and the valve slide are connected with one another in a detachable manner by means of a splint or the like, but can also be designed as a single entity.

The prespecified reference positions are in particular formed by one or more mechanical end stops and/or a defined neutral position of the actuator and/or of the valve slide connected with the actuator. In this case, the characteristic actuating distance of the valve is directly derived from the actuating distance to be traversed between at least one of the end stops and the defined neutral position of the actuator and/or the valve slide.

It is hereby possible for the control unit to recognize the reaching of the mechanical end stops by the detection of a load increase appearing on the actuating unit. The load increase can be determined, for example, as a result of an increasing current requirement of the stepping motor, upon reaching the end stop.

The valve control device in accordance with the invention is explained in more detail below with the aid of the appended drawing. The only FIGURE thereby shows an embodiment example of the valve control device in accordance with the invention for a vehicle.

The vehicle in the case under consideration is a nondepicted agricultural, commercial vehicle, in particular, a tractor, a harvester, a field chopper, or the like.

The valve control device 10 located in the agricultural, commercial vehicle comprises a control unit 12 for the control of an electromagnetically actuatable valve 14 and an actuating unit 18, which is connected with the control unit 12 via a control line 16. The actuating unit 18 is in accordance with the example formed as an electrically controllable actuator in the form of a stepping motor 20, which is connected via a corresponding driving mechanism 22 with a valve slide 26 correlated with the valve 14. The stepping motor 20 and driving mechanism 22 are accommodated in a common housing 24. The valve slide 26 conducted in a valve block 28 can be placed in various positions by means of the stepping motor 20, wherein each of the positions corresponds to a specific valve position.

The actuating distance to be traversed by the valve slide 26 between the various positions is characteristic for the individual type, that is, permits its clear identification for the purpose of the self-calibration of a hydraulic system equipped with it. In other words, the characteristic actuating distance forms an identification feature clearly correlated with the used valve 14.

For the self-calibration of the hydraulic system, the control unit 12 determines the characteristic actuating distance with the aid of prespecified reference positions of an actuator 30 comprised by the actuating unit 18. The actuator 30 is a rack 32 connected with the valve slide 26, and engages with a gear drive 34 of the stepping motor 20. The rack 32 and the gear drive 34 consisting of a first and second gear wheel 36 and 38 are a component of the driving mechanism 22 comprised by the actuating unit 18.

Each of the reference positions of the actuator 30 corresponds hereby to a certain valve position. The actuator 30 and the valve slide 26 are connected with one another in a detachable manner by means of a splint 40 or the like, but can also be designed as a single entity.

At this point, it should be noted that in contrast to the depicted development of the stepping motor 20 as an angular position encoder, it can basically also be a linear path encoder. In this case, the rack 32 and the gear drive 34 can be omitted for the actuation of the valve slide 26. The driving mechanism 22 is then typically designed as a trapezoidal screw driven by the stepping motor 20.

The prespecified reference positions are in accordance with the invention formed by a first mechanical end stop 42 of the actuator 30 and a second end stop 44 of the valve slide 26. In this case, the characteristic actuating distance of the valve 14 is directly deduced from the actuating distance to be traversed between the two end stops 42 and 44 by the actuator 30 or the valve slide 26. Optionally, the prespecified reference positions can also be formed by one individual mechanical end stop 42 or 44 in combination with a defined neutral position of the actuator 30 or the valve slide 26.

The control unit 12 recognizes the reaching of the individual mechanical end stops 42 or 44 by detection of a load increase, which appears on the actuating unit 18. The load increase is determined by the control unit 12 as a result of an increased current need of the stepping motor 20, upon reaching the end stop 42 or 44.

For the self-calibration of the hydraulic system, the control unit 12 requests in a first step the characteristic actuating distance of the valve 14, upon activation of a self-calibration mode. To this end, the actuator 30 is first brought to the first mechanical end stop 42 by a corresponding steering of the actuating unit 18 or the stepping motor 20 comprised by it. Then, the actuator 30 is brought to the second mechanical end stop 44. The characteristic actuating distance is derived by the control unit 12 by detection of the number of steps that the stepping motor 20 requires to completely traverse the actuating distance between the two mechanical end stops 40 and 42. The control unit 12 subsequently determines in a second step a valve type corresponding to the requested characteristic actuating distance. Thereupon, the control unit 12 finally selects in a third step a control algorithm correlated with the determined valve type to control the electromagnetically actuatable valve 14.

The valve control device 10 simplifies not just a first configuration of the hydraulic system provided in the agricultural, commercial vehicle for the case of a plurality of available valve options, but rather also a later replacement of the valve type within the scope of maintenance or revision operations. The various valve types and their corresponding identification features or control algorithms are hereby deposited in tables in a storage device 46 correlated with the control unit 12. After the configuration of the hydraulic system has been completed, the self-calibration mode is abandoned and the valve control device 10 is placed in a normal operating mode provided for the normal operation of the hydraulic system.

1. Valve control device for a vehicle, in particular, an agricultural, commercial vehicle, with a control unit (12) for the control of an electromagnetically actuatable valve (14), wherein upon activation of a self-calibration mode, the control unit (12) requests an identification feature correlated with the electromagnetically actuatable valve (14), determines a valve type corresponding to the requested identification feature, and selects a control algorithm correlated with the determined valve type to control the electromagnetically actuatable valve (14), characterized in that the identification feature is a characteristic actuating distance of an actuating unit (18) provided for electromagnetic actuation of the valve (14).

2. Valve control device according to claim 1, characterized in that the control unit (12) determines the characteristic actuating distance with the aid of prespecified reference positions of an actuator (30) comprised by the actuating unit (18).

3. Valve control device according to claim 2, characterized in that the prespecified reference positions are formed by one or more mechanical end stops (40, 42) and/or a defined neutral position of the actuator (30) and/or a valve slide (26) connected with the actuator (30).

4. Valve control device according to claim 3, characterized in that the control unit (12) recognizes the reaching of the mechanical end spots (40, 42) by the detection of a load increase, which appears on the actuating unit (18).

5. Vehicle, in particular, an agricultural, commercial vehicle, with a valve control device (10) according to one of claims 1 to 4.
